(19) United States
(12) Patent Application Publication
(10) Pub. No.: US 2011/0036375 A1
(43) Pub. Date: Feb. 17, 2011

(54) Tool cleaning method for drywall tools and other applications

(76) Inventor: Harold O. Dewall, Fallbrook, CA (US)

Correspondence Address: Mr. Loyal M. Hanson;Hanson Law Corporation, P.O. Box 430, Fallbrook, CA, 92088-0430, US

(21) Appl. No.: 12/583,228

(22) Filed: Aug. 17, 2009

(51) Int. Cl. B08B 3/02; C02F 1/52

(52) U.S. Cl. 134/13; 134/104.4

(57) ABSTRACT

A method for cleaning drywall tools and other objects produces dirty water while collecting the dirty water in a container. The method includes treating the dirty water in the container with a water-clarifying agent to produce settled-out mud and/or other settled-out constituents and clarified water, removing the clarified water from the container, and, preferably, draining the settled-out mud or other settled-out constituents from the container for recycling. An apparatus includes a cart supporting a container that includes an upwardly opening main portion over which the user sprays the object and a lower portion extending downwardly from the main portion. The lower portion has a bottom end that includes a valve-controlled outlet for enabling the user to drain a quantity of settled-out mud or other settled-out constituents from the container after that quantity has settled out of suspension from the dirty water.

### BACKGROUND OF THE INVENTION

1. Technical Field

This invention relates generally to the field of building construction. It relates more particularly to drywall, drywall installation equipment, and an apparatus and method for cleaning tools and other objects, including the tools used for drywall installation.

2. Description of Related Art

Drywall panels are used in the construction of buildings. Made of a paper liner wrapped around an inner core of gypsum plaster or the like, the panels are also referred to as gypsum board, plasterboard, and sheetrock. Installation involves the use of various drywall tools to prepare and apply drywall joint compound (i.e., a fluid slurry often referred to as “mud”) in the process of taping joints between drywall panels and otherwise installing the drywall. The mud may, for example, include such constituents as water, limestone, expanded perlite, ethylene-vinyl acetate polymer, and attapulgite that are blended in a delicate mixture having a creamy texture that facilitates application.

After applying the mud, the drywall installer cleans the drywall tools in order to remove accumulated mud. Existing tool-cleaning techniques often proceed by simply spraying the tools with water from a hose. The water rinses the mud from the tools, thereby producing dirty water (i.e., turbid water that is cloudy due to the presence of fine particles of mud constituents suspended in the water). In bygone days, the dirty water was allowed to flow to a nearby drain and from there into a public water drainage system. Nowadays, however, various laws and regulations forbid the introduction of contaminants into the water drainage system that way and so tools are often cleaned by spraying them with a hose over a barrel. The barrel catches the dirty water so that it can be disposed of in an allowable manner at a later time.

Just exactly how a drywall installer should dispose of a barrel of dirty water remains a problem, however. One way, is to carry barrels to another site where dirty water dumping is permitted. Another way is to drain the barrels into a larger container for transport. Yet another, generally unused, time-consuming way is to wait for particles suspended in the dirty water to settle to the bottom of the barrel and then discard the clearer water on top. Those existing techniques can be time consuming and expensive, and the problem is compounded when installing drywall several stories above ground level. Thus, a need exists for a tool-cleaning system for drywall tools and other applications that alleviates the foregoing concerns.

### SUMMARY OF THE INVENTION

In view of the foregoing, it is an object of the present invention to fill the above-described need with a suitable tool-cleaning system for drywall tools and/or other objects and for other applications. Predicated on a recognition of the problems involved and the discovery that a water-clarifying agent can quickly settle the mud constituents suspended in dirty water out of suspension, the present invention achieves the above-stated objective by providing an apparatus and method for cleaning tools, and/or other objects, by using such a water-clarifying agent. The method of the present invention treats a container of the dirty water with a water-clarifying agent (and, preferably, an anti-foaming agent also) to quickly produce settled-out mud (i.e., mud constituents and/or other constituents previously in suspension) and clarified water. The structure of the present invention provides an apparatus with a suitable container having features that facilitate tool cleaning, collection of the dirty water, water clarification with the water-clarifying agent (and anti-foaming agent), removal of the resulting clarified water, and recycling of the settled-out mud and/or other settled-out constituents.

To paraphrase some of the more precise language appearing in the claims and further introduce the nomenclature used, the invention provides a method for cleaning tools and other objects that includes rinsing the tools and other objects with water to produce dirty water while collecting the dirty water in a container. The method proceeds by treating the dirty water in the container with a water-clarifying agent to produce settled-out mud (and/or other constituents) and clarified water, and then removing the clarified water and/or removing the settled constituents from the container. Preferably, the method includes the steps of removing the settled-out mud (and/or other settled-out constituents) from the container for recycling. Preferably, the dirty water is also treated with an anti-foaming agent (e.g., an anti-foaming agent that helps in the separation of the mud).

According to the structural aspect of the invention, an apparatus for use in cleaning drywall tools and/or other objects includes a cart and a container on the cart for collecting dirty water as the dirty water is produced by a tool-cleaning event or other object-cleaning event in which a user sprays a drywall tool (or other object) with water in the process of rinsing mud (or other matter) from the drywall tool (or other object). The container includes an upwardly opening main portion over which the user sprays the drywall tool (or other object) and a lower portion extending downwardly from the main portion. The lower portion of the container has a bottom end that includes means in the form of a valve-controlled outlet for enabling the user to drain a quantity of settled-out mud (or other settled-out constituents) from the container after the settled-out mud (or other settled-out constituents) has settled out of suspension from the dirty water.

Preferably, the apparatus includes a water-pressurizing component on the cart having a water inlet and a pressurized-water outlet. Also, a splash guard component that extends upwardly beyond the upwardly opening main portion of the container, along with a shelf component in a position above the upwardly opening main portion of the container and a grill component within the container that is located in a position above the lower portion of the container.

Thus, the invention provides a method and tool-cleaning apparatus (i.e., object-cleaning apparatus) that facilitate tool cleaning, collection of the dirty water, water clarification with the water-clarifying agent (and, preferably, the anti-foaming agent), removal of the resulting clarified water, and recycling of the settled-out constituents. The following illustrative drawings and detailed description make the foregoing and other objects, features, and advantages of the invention more apparent.

### BRIEF DESCRIPTION OF THE DRAWINGS

FIG. 1 of the drawings is a perspective view of a tool-cleaning apparatus constructed according to the invention;

FIG. 2 is an exploded view of the tool-cleaning apparatus;

FIG. 3 is an enlarged exploded view of the container, splash shield, and shelf components; and

FIG. 4 is a block diagram of the methodology employed.

### DESCRIPTION OF THE PREFERRED EMBODIMENTS

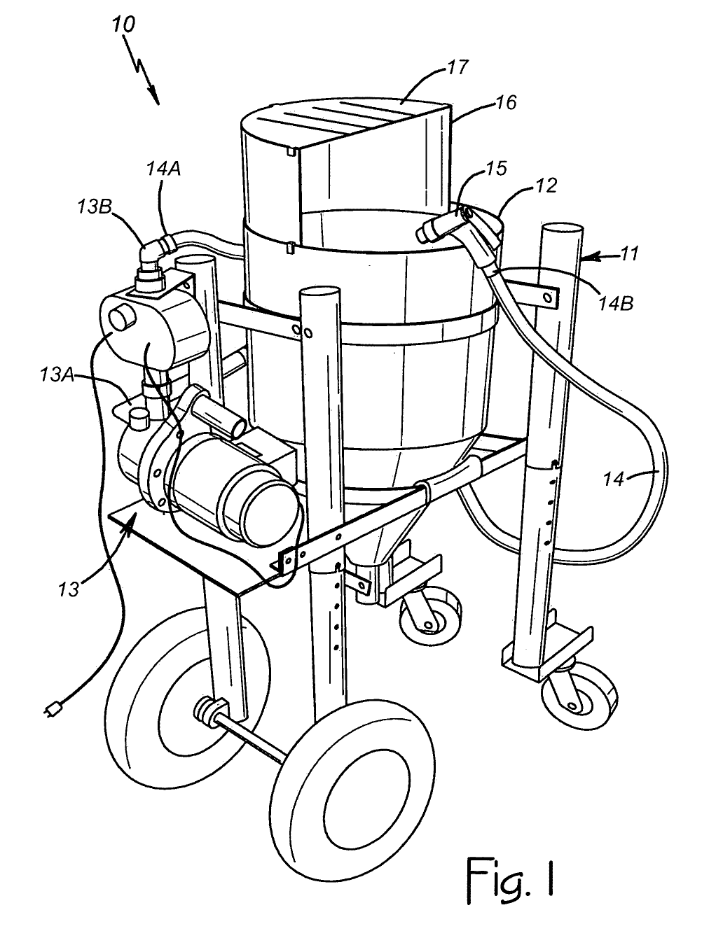

FIG. 1 of the drawings shows a tool-cleaning apparatus 10 constructed according to the invention. Generally, the apparatus 10 includes a cart 11 and a container 12 on the cart 11. The cart 11 supports the container 12 along with an electrically powered water-pressurizing component 13 having an inlet 13A and an outlet 13B. A flow of clear water received from a separate source of water (not shown) that is connected to the inlet 13A, is pressurized by the water-pressurizing component 13 and discharged through the outlet 13B to a flexible hose 14. A first end 14A of the hose 14 is connected to the outlet 13B while a second end 14B of the hose 14 is connected to a spray nozzle 15.

A drywall installer or other operator of the apparatus 10 uses the nozzle 15 to selectively spray the pressurized water on drywall tools (not shown) in the processing of cleaning the tools (i.e., rinsing accumulated mud from the tools). The operator rinses the tools over the container 12 so that the water and mud are collected in the container 12 as “dirty water” (i.e., a cloudy mixture of water and mud constituents and/or other constituents suspended in the water). A splash guard component 16 mounted removably on the container 12 provides a shield that helps confine the dirty water to the container 12. A shelf component 17 mounted removably on the splash guard component 16 provides a convenient support for the tools.

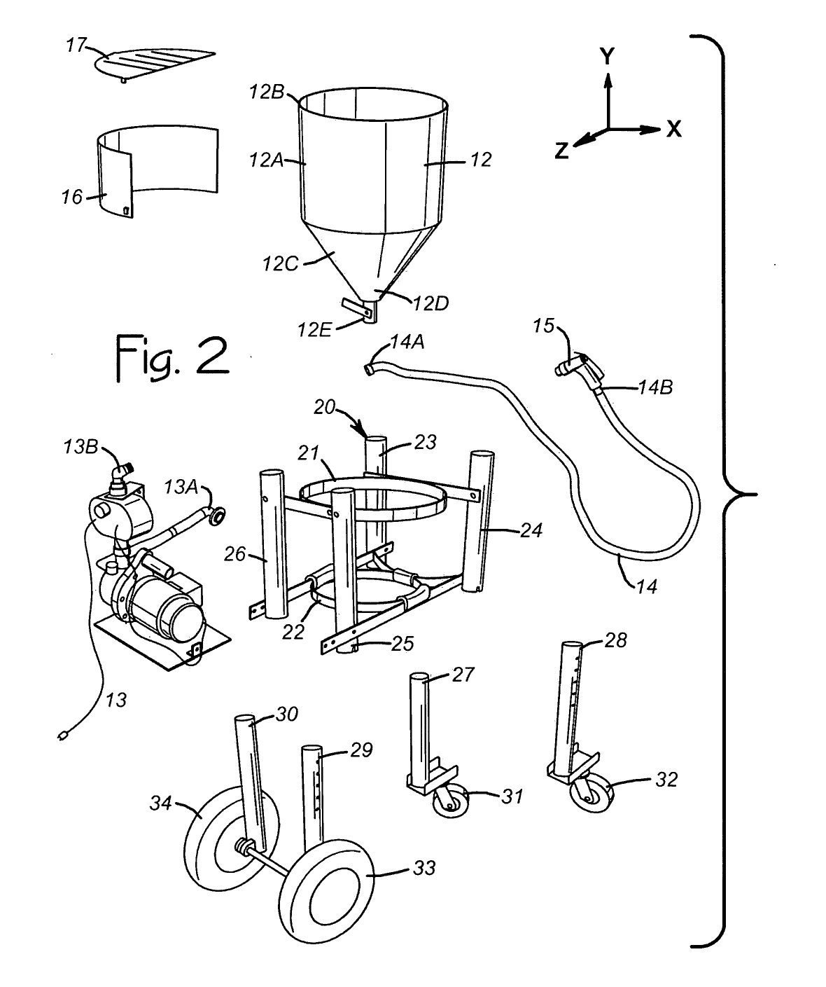

Further details of the apparatus 10 are shown in the exploded view of FIG. 2, with an X-Y-Z Cartesian coordinate system being included in FIG. 2 for reference in describing the spatial orientation of the various components. The container 12 (e.g., a fifteen or twenty-gallon container composed of plastic) includes an upwardly opening main portion 12A (e.g., a cylindrically shaped portion measuring about two feet in diameter) that extends upwardly (i.e., parallel to the vertical Y axis of the X-Y-Z Cartesian coordinate system) to an open end 12B and downwardly to a lower portion 12C. The lower portion 12C (e.g., conically shaped) extends downwardly from the main portion 12A to a bottom end 12D of the container 12 that includes means in the form of a valve-controlled outlet 12E (one-inch pipe) for enabling the user to drain a quantity of settled-out mud from the container 12 after it has settled out of suspension from dirty water in the container 12.

The container 12 is held on a metal frame 20 portion of the cart 12 with two metal bands 21 and 22. The frame 20 includes four leg-receiving tubes 23, 24, 25, and 26 that receive metal tubular legs 27, 28, 29, and 30 so that the legs 27-30 can be adjusted in order to thereby adjust the height of the frame 20. The legs 27-30 include wheels 31, 31, 33, and 34 that facilitate cart movement about a job site.

The frame 20 also supports the water-pressurizing component 13. The component 13 may, for example, take the form of a commercially available, electrically powered pump having demand control. It receives a flow of water from a separate source of water coupled to the inlet 13A and discharges pressurized water from the outlet 13B to the hose 14 according to the demand for water resulting from user operation of the nozzle 15. The water-pressurizing component 13 is configured for ease of assembly to the frame 20 so that the entire apparatus 20 can be conveniently disassembled for cleaning, repair, and transportation when desired. It may include, for example, a centrifugal or bellows-type pump, a bellows-type pump appearing to withstand abrasives better. The pump may be 110-volt or 12-volt model, for example, with the 12-volt model including a battery and inverter-charger as a unit. Preferably, the pump intake enters above the water line. In addition, a flexible hose with a screen is located on the inside of the container 12 near the top; while washing, the user lowers it to the settled-out mud in order to pumped the mud into another container for recycling. Since the pumped-out mud is screened, only unusable mud will remain at the bottom of the container which can be discarded out the valve-controlled outlet 12E.

The illustrated splash guard component 16 is a detachable semi-circular component measuring about twelve inches high. Alternatively, the splash guard component 16 may be formed integrally with the main portion 12A of the container 12 so that it is permanently attached to the container 12. The shelf component 17 sits atop the splash guard component 16. Tools are placed on the shelf component 17 where they drip dry. Preferably, the shelf component 17 includes grooves that help direct water dripping from the tools so that the water drains into the container 12. As a further idea of size, the total height of the illustrated container 12 and splash guard component 16 above the valve-controlled outlet 12E is about 38 inches. Of course, dimensioning may vary significantly without departing from the scope of the claims.

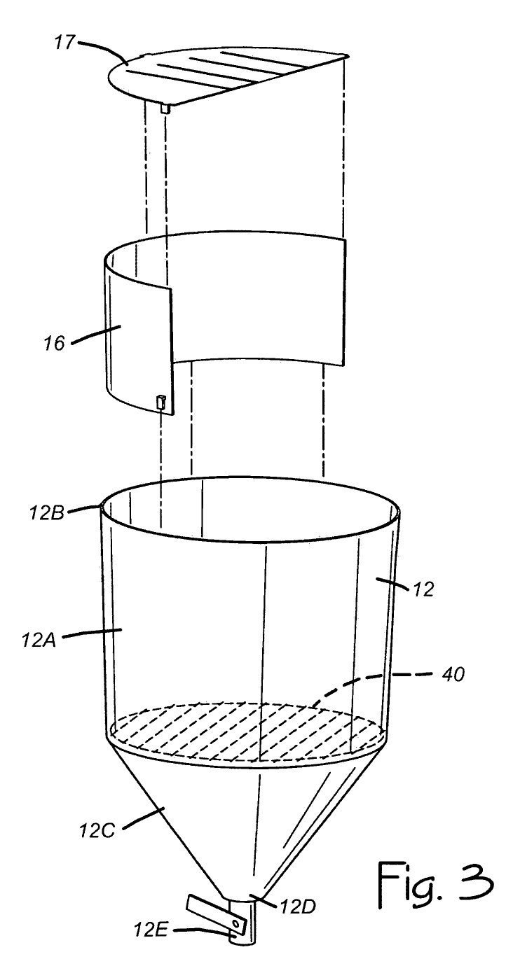

FIG. 3 is an enlarged exploded view of the container 12, splash guard component 16, and shelf component 17. Also shown in FIG. 3 is a grill component 40 that occupies a position in the container 12 above the lower portion 12C. The grill component 40 helps keep tools from falling into settled-out mud.

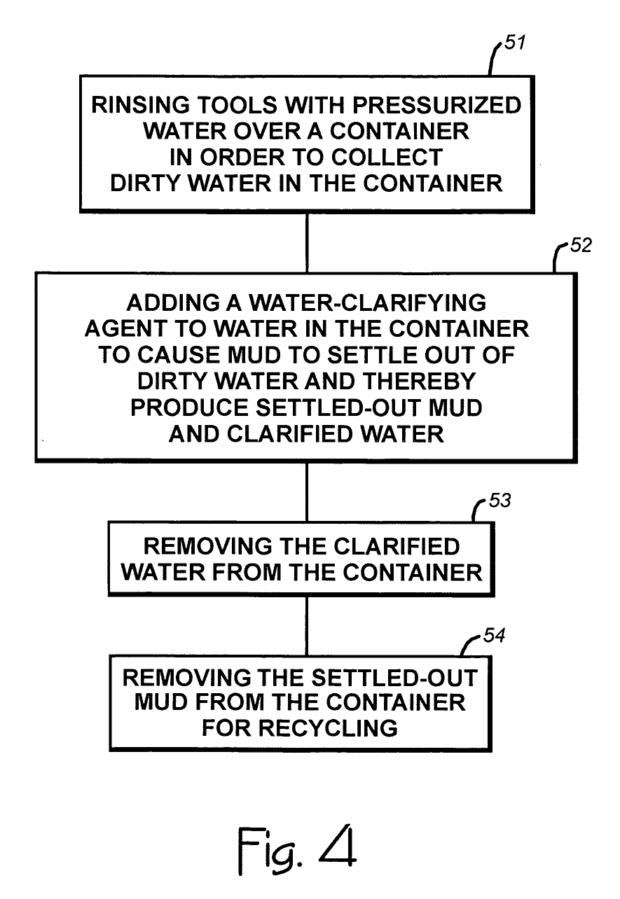

Turning now to FIG. 4, it shows a block diagram of the steps involved in cleaning tools according to the methodology of the invention. The method includes the step of rinsing the tools (or other objects) with water to produce dirty water while collecting the dirty water in a container. This step is indicated by a block 51 in FIG. 4. The method proceeds by treating water in the container with a water-clarifying agent to produce settled-out mud (or other settled-out constituents) and clarified water as represented by a block 52. Preferably, the above steps include adding a quantity of water (e.g., several gallons) to the container first, then adding the water-clarifying agent to that quantity of water, and thereafter rinsing the tools or other objects over the container (i.e., the water-clarifying agent is added before rinsing the tools or other objects). After the tools or other objects have been rinsed and the dirty water treated, the tool-cleaner person removes the clarified water from the container as indicated by a block 53, and drains the settled-out mud or other settled-out constituents from the container as indicated by a block 54, preferably recycling the settled-out mud or other settled-out constituents thereafter.

As used herein, the terms “water clarifier” and “water-clarifying agent” include known types of chemical compounds used to gather (e.g., coagulate or agglomerate) and/or to precipitate suspended particles (e.g., constituents of mud) so they may be removed from the water in which they are suspended. Those terms include the substances called coagulants and flocculents. They also include inorganic salts or aluminum (alum) and other metals or water-soluble organic polyelectrolytes. A suitable clarifying agent (i.e., mud-settling wash-water additive) is commercially available under the trademark MUDMASTER from Mudmaster, Inc. of Escondido, Calif. It is available in a twelve-ounce bottle, that amount being sufficient to treat fifteen gallons of dirty water. Preferably, the step of treating the dirty water also includes treating the dirty water with an anti-foaming agent (e.g., a known type of anti-foaming agent).

Thus, the invention uses a bio-degradeable chemical cocktail (i.e., water clarifying agent) to separate particulates without foaming for the purpose of clarifying water for reuse and possible recycling of the particulates. Predicated on a recognition of the problems involved and the discovery that a water-clarifying agent can quickly settle the mud constituents (and/or other constituents) suspended in dirty water out of suspension, the present invention provides a tool-cleaning method and apparatus that alleviates concerns associated with prior art techniques. The invention facilitates tool cleaning, collection of the dirty water, water clarification with the water-clarifying agent (and, preferably, an anti-foaming agent also), removal of the resulting clarified water, and recycling of the settled-out mud or other settled-out constituents. And, the method applies to other particulates than mud constituents.

Although an exemplary embodiment has been shown and described, one of ordinary skill in the art may make many changes, modifications, and substitutions without necessarily departing from the spirit and scope of the invention. As for the specific terminology used to describe the exemplary embodiment, it is not intended to limit the invention; each specific term is intended to include all technical equivalents that operate in a similar manner to accomplish a similar purpose or function.

What is claimed is:

1. A method for cleaning drywall tools, comprising:
rinsing the tools with water to produce dirty water while collecting the dirty water in a container;
treating the dirty water in the container with a water-clarifying agent to produce settled-out mud and clarified water; and
removing the clarified water from the container.

2. A method as recited in claim 1, further comprising removing the settled-out mud from the container for recycling.

3. A method as recited in claim 1, wherein the step of treating the dirty water includes treating the dirty water with a water-clarifying agent available under the trademark MUDMASTER from Mudmaster, Inc. of Escondido, Calif.

4. A method as recited in claim 3, wherein the step of treating the dirty water includes adding the water-clarifying agent in a ratio of about 12 ounces of the water-clarifying agent to about fifteen gallons of dirty water.

5. A method as recited in claim 1, further comprising a step of treating the dirty water with an anti-foaming agent.

6. A method as recited in claim 1, further comprising a step of providing a container in which to collect the dirty water.

7. An apparatus for use in cleaning objects, the apparatus comprising:
a cart; and
means in the form of a container on the cart for collecting dirty water as the dirty water is produced by an object-cleaning event in which a user sprays an object with water in the process of rinsing matter from the object;
wherein the container includes an upwardly opening main portion over which the user sprays the object and a lower portion extending downwardly from the main portion;
wherein the lower portion of the container has a bottom end of the container; and
wherein the bottom end of the container includes means in the form of a valve-controlled outlet for enabling the user to drain a quantity of settled-out constituents from the container after that quantity of settled-out constituents has settled out of suspension from the dirty water.

8. An apparatus as recited in claim 7, further comprising a water-pressurizing component on the cart having a water inlet and a pressurized-water outlet.

9. An apparatus as recited in claim 7, further comprising a shelf component in a position above the upwardly opening main portion of the container.

10. An apparatus as recited in claim 7, further comprising a splash guard component that extends upwardly beyond the upwardly opening main portion of the container.

11. A method for cleaning objects, comprising:
rinsing the objects with water to produce dirty water while collecting the dirty water in a container;
treating the dirty water in the container with a water-clarifying agent to produce settled-out constituents and clarified water; and
removing the clarified water from the container.

12. A method as recited in claim 11 further comprising removing the settled-out constituents from the container for recycling.

13. A method as recited in claim 11, further comprising a step of providing a container in which to collect the dirty water.
